(19) United States
(12) Patent Application Publication
(10) Pub. No.: US 2024/0149890 A1
(43) Pub. Date: May 9, 2024

(54) ON-VEHICLE SYSTEM

(71) Applicant: TOYOTA JIDOSHA KABUSHIKI KAISHA, Toyota-shi Aichi-ken (JP)

(72) Inventors: Tomohiro KANEKO, Mishima-shi Shizuoka-ken (JP); Shigeki NAKAYAMA, Mishima-shi Shizuoka-ken (JP); Kotoru SATO, Hadano-shi Kanagawa-ken (JP)

(73) Assignee: TOYOTA JIDOSHA KABUSHIKI KAISHA, Toyota-shi Aichi-ken (JP)

(21) Appl. No.: 18/370,618

(22) Filed: Sep. 20, 2023

(30) Foreign Application Priority Data
Nov. 4, 2022 (JP) 2022-177008

(51) Int. Cl. B60W 50/00; B60W 30/14; B60W 40/08; G06V 10/82; G06V 20/59; G06V 40/16

(52) U.S. Cl. CPC B60W 50/0098; B60W 30/146; B60W 40/08; G06V 10/82; G06V 20/593; G06V 40/174; B60W 2420/42; B60W 2540/043; B60W 2540/22

(57) ABSTRACT

An on-vehicle system includes: a control device; an in-vehicle sensor that detects whether there is a priority target among occupants in a vehicle; and a storage device that stores a learned model for feeling estimation. Further, the control device: determines whether there is a priority target among occupants in the vehicle based on a detection result of the in-vehicle sensor; acquires information on the priority target when determining that there is the priority target; estimates a feeling of the priority target based on the information that has been acquired by using the learned model; and executes vehicle control in accordance with a result of estimating the feeling of the target occupant.

### CROSS-REFERENCE TO RELATED APPLICATION(S)

The present application claims priority to and incorporates by reference the entire contents of Japanese Patent Application No. 2022-177008 filed in Japan on Nov. 4, 2022.

### BACKGROUND

The present disclosure relates to an on-vehicle system.

Japanese Laid-open Patent Publication No. 2019-098779 discloses a technique for generating driving advice based on a feeling difference between a driver and an occupant.

### SUMMARY

There is a need for providing an on-vehicle system capable of inhibiting failure of vehicle control based on feeling.

According to an embodiment, an on-vehicle system includes: a control device; an in-vehicle sensor that detects whether there is a priority target among occupants in a vehicle; and a storage device that stores a learned model for feeling estimation. Further, the control device: determines whether there is a priority target among occupants in the vehicle based on a detection result of the in-vehicle sensor; acquires information on the priority target when determining that there is the priority target; estimates a feeling of the priority target based on the information that has been acquired by using the learned model; and executes vehicle control in accordance with a result of estimating the feeling of the target occupant.

### BRIEF DESCRIPTION OF THE DRAWINGS

FIG. 1 schematically illustrates a vehicle in which an on-vehicle system according to a first embodiment is mounted;

FIG. 2 is a flowchart illustrating one example of control performed by a control device;

FIG. 3 schematically illustrates a vehicle in which an on-vehicle system according to a second embodiment is mounted; and

FIG. 4 schematically illustrates a vehicle in which an on-vehicle system according to a third embodiment is mounted.

### DETAILED DESCRIPTION

In the related art, when a plurality of occupants is in a vehicle, at least some of the occupants may have feeling different from those of the other occupants, which may prevent vehicle control based on feeling.

### First Embodiment

A first embodiment of an on-vehicle system according to the present disclosure will be described below. Note that the present embodiment does not limit the present disclosure.

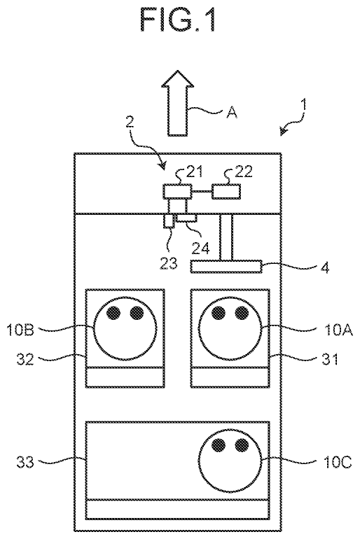

FIG. 1 schematically illustrates a vehicle 1 in which an on-vehicle system 2 according to the first embodiment is mounted.

As illustrated in FIG. 1, the vehicle 1 according to the embodiment includes the on-vehicle system 2, a steering wheel 4, front seats 31 and 32, and a rear seat 33. Note that an arrow A in FIG. 1 indicates a traveling direction of the vehicle 1.

Occupants 10A, 10B, and 10C are sitting on the front seats 31 and 32 and the rear seat 33, respectively. The occupant 10A seated on the front seat 31 facing the steering wheel 4 is a driver of the vehicle 1. Note that, in the following description, the occupants 10A, 10B, and 10C are simply referred to as occupants 10 unless otherwise distinguished.

The on-vehicle system 2 includes a control device 21, a storage device 22, an in-vehicle camera 23, and an operation panel 24.

The control device 21 includes, for example, an integrated circuit including a central processing unit (CPU). The control device 21 is communicably connected to the storage device 22, the in-vehicle camera 23, and the operation panel 24. The control device 21 executes a program and the like stored in the storage device 22. Furthermore, the control device 21 acquires image data from the in-vehicle camera 23, for example.

The storage device 22 includes at least one of, for example, a read only memory (ROM), a random access memory (RAM), a solid state drive (SSD), and a hard disk drive (HDD). Furthermore, a storage device 22 does not need to be physically one element, and may have a plurality of physically separated elements. The storage device 22 stores a program and the like executed by the control device 21. Furthermore, the storage device 22 also stores various pieces of data to be used at the time of execution of a program, such as a learned model for determining whether a person is weak in a vehicle, a learned model used for feeling estimation, and a learned model for vehicle control. These learned models correspond to a trained machine learning model to be described later.

As illustrated in FIG. 1, the in-vehicle camera 23 is an imaging device disposed at a position where the in-vehicle camera 23 can image the plurality of occupants 10A, 10B, and 10C in the vehicle. The in-vehicle camera 23 functions as an in-vehicle sensor for detecting a weak person in a vehicle from the plurality of occupants 10A, 10B, and 10C in the vehicle. The weak person in a vehicle is a priority target such as an elderly person, a child, a disabled person, and a person requiring care. The in-vehicle camera 23 outputs image data serving as sensor data. Image data obtained by the in-vehicle camera 23 is transmitted to the control device 21, and temporarily stored in the storage device 22.

Here, the “elderly person” refers to a member of a group of members who are older than other members in society, and the reference age may be appropriately defined. In one example, the elderly person may be defined as a person 65 years of age or over. In another example, the elderly person may be defined not absolutely by age but in consideration of other factors such as physical ability (for example, the elderly person may be defined as a person with physical ability decreased by age). Here, the “child” refers to a member of a group of members who are younger than other members in society, and the reference age may be appropriately defined. In one example, the child may be defined as a person younger than 18 years of age, younger than 15 years of age, younger than 12 years of age, or younger than 6 years of age. In another example, the child may be defined not absolutely by age but in consideration of other factors such as physical ability (for example, the child may be defined as a person who uses a child seat). The “disabled person” may be appropriately defined to include at least any one of a physically disabled person, an intellectually disabled person, and a mentally disabled person. In one example, the “disabled person” may be defined as a person who is continuously restricted from performing daily life or social life due to a lack of physical ability or the like. The “person requiring care” may be defined as a person who requires care. The range of care is not required to be particularly limited, and may be appropriately determined in accordance with the embodiment.

The operation panel 24 is an input/output device such as a touch panel display provided in the vicinity of a driver seat. The operation panel 24 receives an operation instruction from the occupant 10 such as the driver, and provides information to the occupant 10.

The control device 21 can detect the attribute, the expression, and the like of the occupant 10 based on the image data obtained by the in-vehicle camera 23. That is, the control device 21 can determine the attribute of the occupant 10 such as a weak person in the vehicle, the feeling of the occupant 10, and the like by artificial intelligence (AI) using a learned model subjected to machine learning based on the image data. Moreover, the control device 21 can determine the content of the vehicle control from the feelings of the occupant 10 by AI using the learned model subjected to machine learning.

The learned model for determining whether a person is weak in a vehicle is a trained machine learning model, and has been subjected to machine learning so as to output a result of determining a weak person in a vehicle from input data by supervised learning in accordance with a neural network model, for example. The learned model for determination is generated by repeatedly executing learning processing using a learning data set, which is a combination of input data and result data. The learning data set includes, for example, a plurality of pieces of learning data obtained by applying a label of whether a person is weak in a vehicle, which is output, to input data on the appearance of the occupant 10, whether the occupant 10 uses a wheelchair, and the like given as input. For example, a person skilled in the art applies the label of whether a person is weak in a vehicle to the input data. As described above, when receiving input data, the learned model for determination learned by using the learning data set outputs whether a person is weak in a vehicle by executing arithmetic processing of the learned model.

The learned model for feeling estimation is a trained machine learning model, and has been subjected to machine learning so as to output a feeling estimation result from input data by supervised learning in accordance with the neural network model, for example. The learning data set in the learned model for feeling estimation includes, for example, a plurality of pieces of learning data obtained by applying a label of a feeling of the occupant 10, which is output, to input data of image data having expression of a person including expression and the like of the occupant 10 given as input. For example, a person skilled in the art applies the label of feeling of the occupant 10 to the input data. As described above, when receiving input data, the learned model for feeling estimation learned by using the learning data set outputs the feeling of the occupant 10 by executing arithmetic processing of the learned model.

Note that data used for determining whether the occupant 10 is weak in a vehicle may be the same as or different from data used for estimating the feeling of the occupant 10.

The learned model for vehicle control is a trained machine learning model, and has been subjected to machine learning so as to output a result of the content of the vehicle control from input data by supervised learning in accordance with the neural network model, for example. The learning data set in the learned model for vehicle control includes, for example, a plurality of pieces of learning data obtained by applying a label of the content of the vehicle control, which is output, to input data such as feeling of the occupant 10 given as input. For example, a person skilled in the art applies the label of the content of the vehicle control to the input data. As described above, when receiving input data, the learned model for vehicle control learned by using the learning data set outputs the content of the vehicle control by executing arithmetic processing of the learned model. Examples of the content of the vehicle control include limiting a range of acceleration and setting a steering angle and a lateral G to a threshold or less. Furthermore, examples of the content of the vehicle control may include softening a suspension of the vehicle 1 to improve ride comfort in a case where an elderly person is detected as a weak person in a vehicle, for example. The control device 21 executing the vehicle control includes executing vehicle control of limiting a range of acceleration in a case where a result of estimating feeling of a priority target indicates that the priority target expresses unpleasant feeling.

Note that, when determining the content of the vehicle control, the control device 21 may determine the content of the vehicle control from the feeling of the occupant 10 based not on the learned model for vehicle control but on a rule obtained by associating a feeling of the occupant 10 with the content of the vehicle control.

For example, the control device 21 determines whether a weak person in a vehicle, such as an elderly person, a child, and a disabled person, is on board and specifies a boarding position (seated position) of the weak person in the vehicle based on a detection result from an in-vehicle sensor such as the in-vehicle camera 23. The control device 21 determining whether there is a weak person in a vehicle, who is a priority target, among the occupants 10 in the vehicle includes determining whether there is a weak person in the vehicle among the occupants 10 in the vehicle based on image data obtained by an in-vehicle camera 23.

Here, in general, the weak person in a vehicle more easily accumulates fatigue due to the behavior of the vehicle 1 than a person having good physical strength, and has more difficulty in grasping the behavior of the vehicle 1, such as accelerating, decelerating, right turning, left turning, and step following, and more easily has unpleasant feeling due to the behavior of the vehicle 1 than other occupants 10. Therefore, in the on-vehicle system 2 according to the first embodiment, the control device 21 determines whether there is a weak person in a vehicle among the plurality of occupants 10 in the vehicle 1 based on the image data obtained by the in-vehicle camera 23. When a weak person in the vehicle is in the vehicle 1, the control device 21 performs processing of specifying and marking the boarding position (seated position) of the weak person in the vehicle. Then, the control device 21 acquires information on the marked weak person in the vehicle, preferentially estimates the feeling of the weak person in the vehicle. The control device 21 executes vehicle control of restricting acceleration, a steering angle, and the like based on the feeling estimation result. Note that examples of the information on a weak person in a vehicle include image data having expression of the weak person in the vehicle obtained by the in-vehicle camera 23, such as expression of the weak person in the vehicle.

Note that, when the priority order of estimating feeling of a weak person in a vehicle is determined, attributes such as an infant, a child, an elderly person, a wheelchair user, a pregnant female, and a disabled person may be handled in the same order. The priority order may be determined in accordance with a seat position. For example, a higher priority order of feeling estimation may be given to a weak person in a vehicle sitting on the rear seat 33 where carsickness easily occurs than on the front seats 31 and 32. Furthermore, when the driver of the vehicle 1 is a weak person in a vehicle, such as an elderly person, the priority of estimating the feeling of the driver may be set low.

Furthermore, the control device 21 may determine whether the occupant 10 is a weak person in a vehicle from the behavior of the occupant 10 at the time when the occupant 10 gets into the vehicle 1 by using the in-vehicle camera 23. For example, when detecting that the occupant 10 gets into a vehicle from a wheelchair or that it takes a little time for the occupant 10 to get into the vehicle based on the image data obtained by the in-vehicle camera 23, the control device 21 determines that the occupant 10 is a weak person in the vehicle.

Furthermore, in the on-vehicle system 2 according to the first embodiment, seat positions in the vehicle may be displayed on a display of the operation panel 24, and the occupant 10 such as the driver may designate a seat position where a weak person in the vehicle whose feeling is to be preferentially estimated is sitting.

Furthermore, in the on-vehicle system 2 according to the first embodiment, for example, the load of processing performed by the control device 21 may be reduced by determining a weak person in the vehicle only for the elderly or only for the occupant 10 sitting on the rear seat 33, and performing feeling estimation in order of priority.

Furthermore, in the on-vehicle system 2 according to the first embodiment, it may be determined whether the weak person in the vehicle has a “pleasant” feeling or an “unpleasant” feeling due to the behavior of the vehicle 1, and the determination may be reflected in the vehicle control.

Furthermore, in the on-vehicle system 2 according to the first embodiment, when there is no weak person in the vehicle, who is a priority target, a feeling estimation result used for the vehicle control may be selected by any method, or the vehicle control based on the feeling estimation result is not required to be executed.

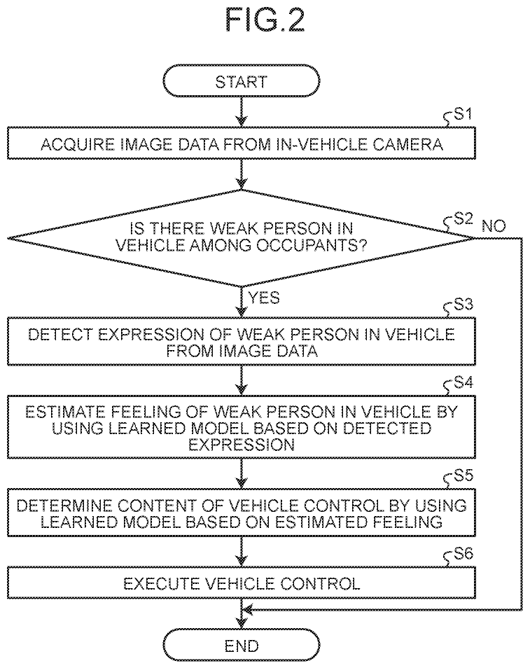

FIG. 2 is a flowchart illustrating one example of control performed by the control device 21.

First, in Step S1, the control device 21 acquires image data obtained by the in-vehicle camera 23. Next, in Step S2, the control device 21 determines whether there is a weak person in a vehicle, who is a priority target, among the plurality of occupants 10 in the vehicle. When determining that there is not a weak person in a vehicle among the occupants 10, the control device 21 determines No in Step S2, and ends a series of controls. In contrast, when determining that there is a weak person in the vehicle among the occupants 10, the control device 21 determines Yes in Step S2, and proceeds to Step S3. In Step S3, the control device 21 detects expression of the weak person in the vehicle from the image data from the in-vehicle camera 23, and acquires information on the weak person in the vehicle. Next, in Step S4, the control device 21 estimates the feeling of the weak person in the vehicle by using the learned model for feeling estimation based on the detected expression of the weak person in the vehicle. Next, in Step S5, the control device 21 determines the content of the vehicle control by using the learned model for vehicle control based on the estimated feeling. Next, in Step S6, the control device 21 executes the vehicle control based on the determined content of the vehicle control. Thereafter, the control device 21 ends the series of controls.

The on-vehicle system 2 according to the first embodiment can inhibit the weak person in the vehicle from being unpleasant by prioritizing the feeling of the weak person in the vehicle, who is a priority target, and executing the vehicle control. Furthermore, in the on-vehicle system 2 according to the first embodiment, when the plurality of occupants 10 is in the vehicle, the feeling estimation result used for the vehicle control can be narrowed to a result of estimating the weak person in the vehicle, who is a priority target. Therefore, the on-vehicle system 2 according to the first embodiment can inhibit failure of the vehicle control based on feeling.

### Second Embodiment

A second embodiment of the on-vehicle system according to the present disclosure will be described below. Note that, in the second embodiment, description of contents common to those of the first embodiment will be appropriately omitted.

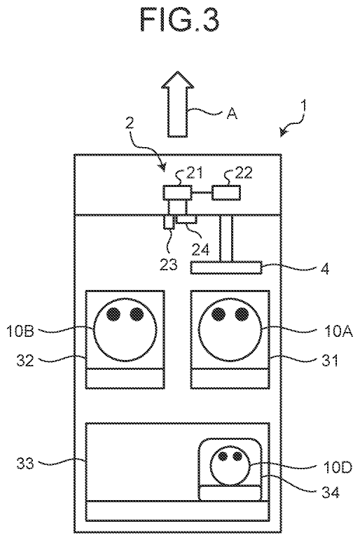

FIG. 3 schematically illustrates the vehicle 1 in which the on-vehicle system 2 according to the second embodiment is mounted.

In the vehicle 1 according to the second embodiment, a child occupant 10D sits on a child seat 34 installed in the rear seat 33. In this case, in the on-vehicle system 2 according to the second embodiment, the control device 21 determines that a weak person in a vehicle is in the vehicle by detecting the child seat 34 and the child occupant 10D sitting on the child seat 34 based on the image data from the in-vehicle camera 23. Note that the learning data set in the learned model for determination includes, for example, a plurality of pieces of learning data obtained by applying a label of whether a person is weak in a vehicle, which is output, to input data of whether the occupant 10 is sitting on the child seat given as input.

The child occupant 10D, who is a weak person in the vehicle, sitting on the child seat 34 cannot predict the behavior of the vehicle 1 such as accelerating, decelerating, right turning, left turning, and step following, so that the child occupant 10D easily gets unpleasant. Therefore, the control device 21 preferentially estimates the feeling of the child occupant 10D, who is a weak person in the vehicle, sitting on the child seat 34 from the expression of the child occupant 10D by using the learned model for feeling estimation based on the image data obtained by the in-vehicle camera 23. Then, the control device 21 executes vehicle control of restricting acceleration and the like by using the learned model for vehicle control based on the feeling estimation result.

Furthermore, in the on-vehicle system 2 according to the second embodiment, for example, a seat belt sensor that detects whether a seat belt is worn may be used as an in-vehicle sensor for detecting a weak person in a vehicle. Then, the control device 21 determines whether the occupant 10 is a priority target of feeling estimation based on whether a seat belt is worn at a seated position of the occupant 10. For example, the control device 21 detects whether a seat belt provided at a seat position of the rear seat 33 where the child seat 34 is installed is worn. When detecting that the seat belt provided at the seat position is not worn, the control device 21 determines that the child occupant 10D at the seat position is a child sitting on the child seat 34, and detects a weak person in the vehicle. Furthermore, in the on-vehicle system 2 according to the second embodiment, whether a child is sitting on the child seat 34 may be determined and a weak person in the vehicle may be detected based on a detection result from a weight sensor provided at the seat position of the rear seat 33 at which the child seat 34 is installed.

### Third Embodiment

A third embodiment of the on-vehicle system according to the present disclosure will be described below. Note that, in the third embodiment, description of contents common to those of the first embodiment will be appropriately omitted.

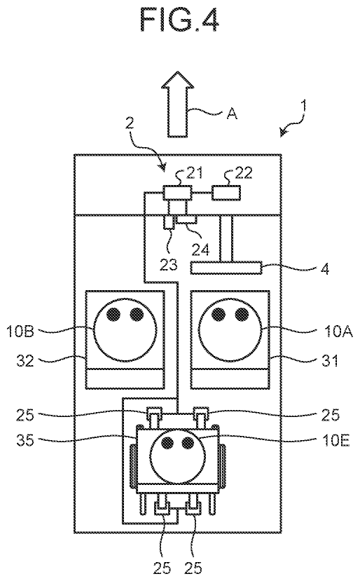

FIG. 4 schematically illustrates the vehicle 1 in which the on-vehicle system 2 according to the third embodiment is mounted.

In the vehicle 1 according to third embodiment, wheelchair space is provided instead of the rear seat, and an occupant 10E sitting on a wheelchair 35 is on board. The wheelchair 35 is fixed in the vehicle by a lock device 25. In this case, in the on-vehicle system 2 according to the third embodiment, the control device 21 determines that a weak person in a vehicle is in the vehicle by detecting the occupant 10E sitting on the wheelchair 35 based on the image data from the in-vehicle camera 23. Note that the learning data set in the learned model for determination includes, for example, a plurality of pieces of learning data obtained by applying a label of whether a person is weak in a vehicle, which is output, to input data of whether the occupant 10 is sitting on the wheelchair given as input.

The occupant 10E sitting on the wheelchair 35 cannot predict the behavior of the vehicle 1 such as accelerating, decelerating, right turning, left turning, and step following, so that the occupant 10E easily gets unpleasant. Therefore, the control device 21 preferentially estimates the feeling of the occupant 10E, who is a weak person in the vehicle, sitting on the wheelchair 35 from the expression of the occupant 10 by using the learned model for feeling estimation based on the image data obtained by the in-vehicle camera 23. Then, the control device 21 executes vehicle control of restricting acceleration and the like by using the learned model for vehicle control based on the feeling estimation result.

Furthermore, in the on-vehicle system 2 according to the third embodiment, for example, a lock sensor that detects whether the wheelchair 35 is locked by the lock device 25 may be used as an in-vehicle sensor for detecting a weak person in a vehicle. The lock sensor is provided in the lock device 25, and communicably connected to the control device 21. Then, for example, when detecting that the wheelchair 35 is locked by the lock device 25 with the lock sensor, the control device 21 determines that the occupant 10E sitting on the wheelchair 35 is on board the vehicle 1, and detects a weak person in the vehicle.

The on-vehicle system according to the present disclosure has an effect of inhibiting failure of vehicle control based on feeling.

According to an embodiment, in the on-vehicle system according to the present disclosure, when a plurality of occupants is in a vehicle, a feeling estimation result used for vehicle control can be narrowed to a result of estimating a priority target. Therefore, the on-vehicle system according to the present disclosure can inhibit failure of vehicle control based on feeling.

According to an embodiment, more comfortable vehicle control can be achieved for a person who more easily accumulates fatigue due to the behavior of a vehicle than a person having good physical strength in general by designating the person who more easily accumulates fatigue as a priority target.

According to an embodiment, feeling can be estimated from the expression of the priority target in image data obtained by an imaging device.

According to an embodiment, whether there is a priority target can be determined based on the image data obtained by the imaging device.

According to an embodiment, the priority target can be inhibited from being unpleasant by sudden acceleration and deceleration.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An on-vehicle system comprising:
a control device;
an in-vehicle sensor that detects whether there is a priority target among occupants in a vehicle; and
a storage device that stores a learned model for feeling estimation,
wherein the control device:
determines whether there is the priority target among occupants in the vehicle based on a detection result of the in-vehicle sensor;
acquires information on the priority target when determining that there is the priority target;
estimates a feeling of the priority target based on the information that has been acquired by using the learned model; and
executes vehicle control in accordance with a result of estimating the feeling of the priority target.

2. The on-vehicle system according to claim 1,
wherein the priority target is at least any one of an elderly person, a child, a disabled person, and a person requiring care.

3. The on-vehicle system according to claim 1, further comprising
an imaging device disposed at a position where a plurality of occupants are allowed to be imaged in the vehicle,
wherein the learned model is generated by machine learning so as to derive a result of estimating feeling of a person based on image data having expression of the person,
the information on the priority target includes image data having expression of the priority target obtained from the imaging device, and
estimating feeling of the priority target using the learned model includes:
giving the image data having expression of the priority target obtained by the imaging device to the learned model; and
obtaining a result of estimating the feeling of the priority target from the learned model by executing arithmetic processing of the learned model.

4. The on-vehicle system according to claim 3,
wherein the in-vehicle sensor includes the imaging device, and
determining whether there is the priority target among occupants in the vehicle includes determining whether there is the priority target among the occupants in the vehicle based on image data obtained by the imaging device.

5. The on-vehicle system according to claim 1,
wherein executing the vehicle control includes executing vehicle control of limiting a range of acceleration in a case where a result of estimating feeling of the priority target indicates that the priority target expresses unpleasant feeling.
